(19) United States
(12) Patent Application Publication
(10) Pub. No.: US 2007/0059095 A1
(43) Pub. Date: Mar. 15, 2007

(54) Animal barn flooring system

(76) Inventor: Graham Kenneth Hines, Exeter (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/312,028

(22) Filed: Dec. 20, 2005

Related U.S. Application Data
(60) Provisional application No. 60/715,397, filed on Sep. 9, 2005.

(51) Int. Cl. E01C 5/18

(52) U.S. Cl. 404/32

(57) ABSTRACT

Concrete slabs including anchored rubber surfaces are described which are useful as flooring elements in barns for cows and other animals. A mat is laid over curing concrete in a slat mold. The undersurface of the mat includes a number of projecting elements which are narrowed by undercuts, so that once cured the mat is “locked” in place by the hardened concrete filling concave recesses in the anchoring elements.

### CROSS REFERENCE TO RELATED APPLICATIONS

This application claims priority from provisional U.S. Patent Application No. 60/715,397, filed on Sep. 9, 2005.

### RELATED APPLICATION

This application is a replacement of and claims priority from Provisional Application No. 60/715,397 filed Sep. 9, 2005 and entitled ANIMAL BARN FLOORING SYSTEM.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF INVENTION

This invention relates to flooring designs and structures for use in the husbandry of domestic animals, in particular cattle, horses and hogs.

### BACKGROUND OF THE INVENTION

It is now a common arrangement in barns for cows for the floor to be of a slotted structure, in which concrete slats, which may be about six inches wide, are separated by gaps of about one and one half inches wide. The purpose of the slats or gaps is to drain off feces and urine produced by the cows. However, the concrete slats can be quite slippery. That can result in the cows falling and injuring themselves. This is a particular problem with older dairy cows, which are the best producers of milk.

It is an object of the present invention to provide concrete slats with embedded rubber surface coverings in a variety of surface textures which are particularly suitable as cow barn flooring elements.

A description of concrete slats including anchored rubber surfaces according to the invention is given in more detail below. We have discovered that a particularly advantageous and economical source of rubber for our invention is readily available as by-product in the manufacture of vehicle tires. Current methods for manufacturing vehicle tires produce a considerable amount of waste rubber which is usually discarded to landfill. The presence of small amounts of residual solvent from the tire molding processes render such rubber unsuitable for vehicle tires, but of a quality entirely satisfactory for application in the present invention.

### DESCRIPTION OF THE INVENTION

The invention contemplates, as an article of manufacture, a rectangular flooring element comprising a concrete slat overlaid with a firmly anchored rubber mat having a top walking surface which is textured for anti-slip properties.

The rubber mat is formed in a “wringer” style machine which forms the rubber (typically, waste tire rubber) into a mat by pressure with the application of heat. Once the rubber has been processed to the approximate desired thickness it is put into a large press which includes first molding elements that are configured to form on one of the two mat faces a regular pattern of slightly convex surface formations to provide a textured slip-resistant surface. The press is provided with second molding elements to form regularly spaced perpendicularly projecting elements on the bottom face of the mat. These projecting elements are narrowed by undercuts so that the projection-bearing surface can be pressed into the curing concrete slat, with the result that the projections on the underface of each mat are embedded and locked into the concrete during the curing process. The press is closed and heat is applied for typically twenty minutes to set or “cure” the rubber in its final shape. The pressing elements are then separated and the rubber removed, put in a water-cutting machine and an array of holes cut therethrough to conform to the cores of the concrete mold.

I have discovered this locking arrangement to be superior to known arrangements that are commonly in use. Two typical flooring structures currently used are (i) the lagging onto the concrete of measured strips of conveyor belting or (ii) a mat formed from crumbed recycled tire rubber, bonded and pressed together is then physically bolted to the concrete slats to form the walking surface. From my observations, the lengths of such recycled tire surface materials suffer fracture as the bonding glue breaks down, through continuing traffic of livestock on the floor surface. The lagging or bolting of lengths of rubber or crumbed mats to the slats also negatively affects the integrity of the concrete itself.

### BRIEF DESCRIPTION OF THE DRAWINGS

The invention will now be described by way of example and reference to the accompanying drawings, in which:

FIG. 1a is a top perspective view of a rubber mat section with pairs of undercut projecting elements according to a first embodiment of the invention;

FIG. 2a is a bottom perspective view thereof;

FIG. 3a is an end elevational view thereof;

FIG. 4a is a side elevational view thereof; and

FIG. 5a is a top plan view thereof.

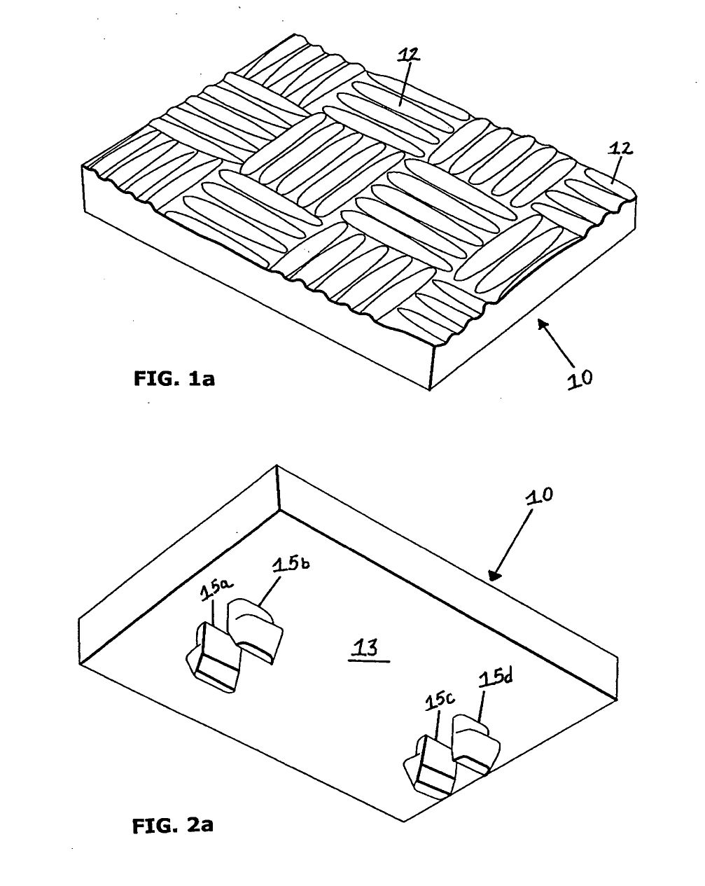

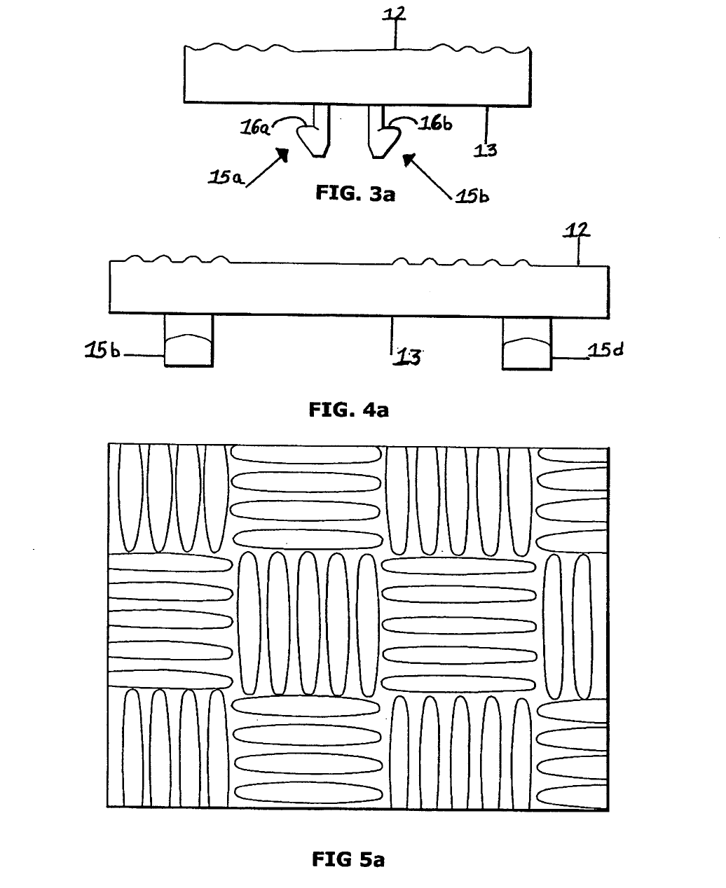

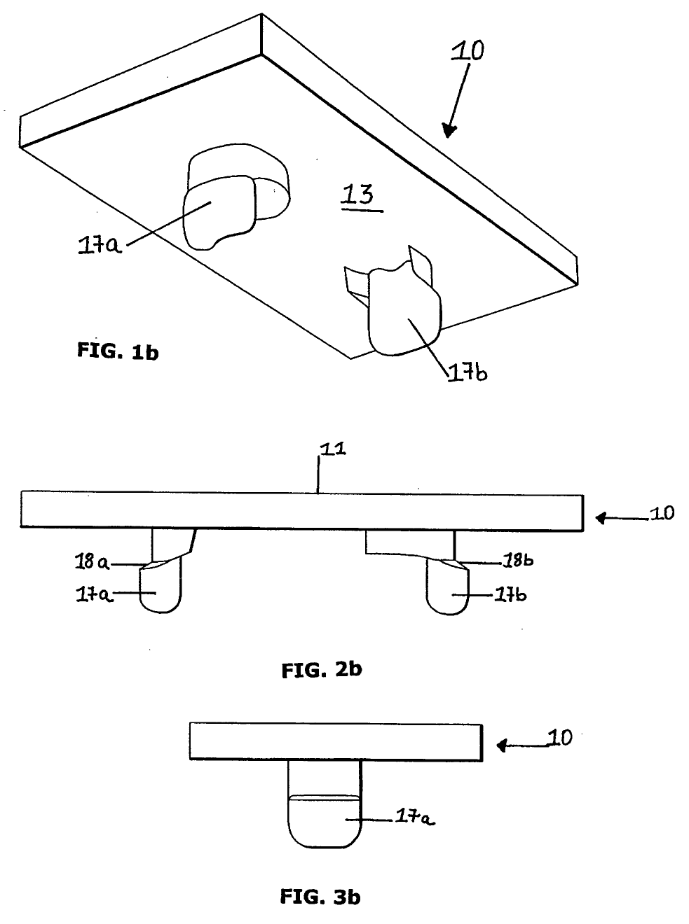

FIG. 1b is a bottom perspective view of a rubber mat section with undercut projecting elements according to a second embodiment of the invention;

FIG. 2b a side elevational view thereof; and

FIG. 3b is an end elevational view thereof.

FIG. 6 gives schematic end elevational sectional views of alternative rubber anchor contours A to T which may be formed integrally with the rubber mat section used in flooring elements with the present invention, to achieve the desired locking of rubber to concrete.

### DETAILED DESCRIPTION OF PREFERRED EMBODIMENTS

Concrete slat flooring elements are first formed by pouring concrete into molds of a suitable rectangular dimension, typically from 2-4 ft wide and up to 14 ft long. The concrete is vibrated to consolidate by settling and removal of bubbles.

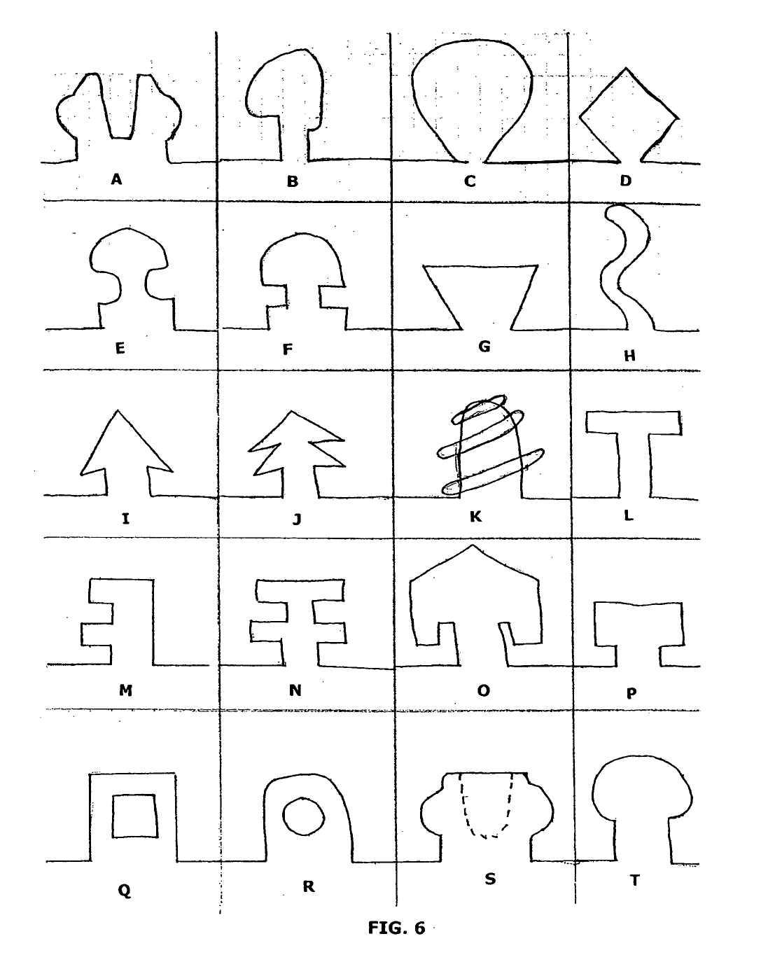

To the surface of an unset concrete slab is pressed a preformed rubber mat of conforming rectangular dimensions. A currently preferred embodiment of such rubber mat is indicated in drawing FIGS. 1a-5a as 10.

The upper, walking surface of mat 10 presents a rectangular pattern of integral, convex surface formations 12, while its lower surface 13 is smooth except for symmetrically disposed integral anchoring projections such as 15a to 15d.

As best seen in FIGS. 2a and 3a, projections 15a to 15d are disposed in symmetric pairs 15a/15b and 15c/15d toward opposite ends of mat underside 13. Each projection is recessed at an undercut surface formation 16a-16d. When the rubber mat 10 is pressed into the wet concrete and projections 15a to 15d are fully embedded therein, concrete flows into the formed recesses to “lock” the projections in place.

When the full complement of laminated concrete slats has been prepared, they are installed on the barn floor. This may be done by a conventional arrangement of posts and beams in which each concrete slat is supported on its ends by a beam which is in turn held up at its ends by vertical posts. Alternatively, the slats may be supported on their ends by a port concrete wall. The lateral gaps between laminated beams in the assembled flooring system are typically about 1% inches wide, to allow for drainage of animal waste.

We have found in comparative studies conducted in a cattle barn fitted out over one half with conventional flooring and over the other with a flooring system according to the present invention that the cattle appeared to be more sure-footed and experienced less stumbling, lay down more comfortably and rose more easily in the region with the floor system of the invention and, indeed, tended to gravitate in numbers over time to that section of the barn.

FIGS. 1 b to 3b show a similar rubber mat 10 configured for embedding of its anchoring projections in concrete slats according to the invention, but having a different form of integral anchoring elements 17a and 17b. These too, however, include the essential feature of a stepped, recessed or undercut portion 18a/18b configured to allow for flowover of wet cement in the lamination step, conducive to locking the anchor elements in place in the concrete.

A variety of shapes of anchoring element which might be used for this purpose are illustrated in the schematic end sectional views of FIG. 6, variants A to T being shown. All feature projections and recesses configured to allow the locking of the rubber anchoring elements into the concrete slats.

Without further elaboration the foregoing will so fully illustrate my invention that others may, by applying current or future knowledge, readily adapt the same for use under various conditions of service.

I claim:

1. A structural flooring element for an animal barn, comprising:
a concrete slat having upper and lower surfaces;
a rubber mat having upper and lower surfaces with its lower surface contiguous with and extending over the upper surface of said concrete slat; and
a plurality of anchoring projections integral with said mat extending perpendicularly downwardly from the lower surface thereof into the concrete material of the slat, each of said anchoring projections having a vertical cross-sectional shape which includes at least one undercut horizontal surface defining a concave recess which in use is filled with concrete,
the upper surface of said mat presenting a textured surface to reduce slipping or skidding of an animal traversing the surface of the flooring element.

2. A structural flooring element according to claim 1, wherein said anchoring projection includes a stem portion extending perpendicularly downwardly from the underside of the mat and terminating in a horizontally stepped portion axially displaced from the stem, defining said concave recess at the juncture of the stem and the stepped portion of the anchoring projection.

3. A structural flooring element according to claim 1, wherein the lower part of said anchoring projection is in the form of an inverted triangle with a portion of its base extending horizontally away from the stem portion of the anchoring projection.

4. A structural flooring element according to claim 1, wherein the textured upper surface of said mat presents a regular array of rectangular subsections, each subsection containing a selected number of parallel, elongate oval convex ridges, the ridges of any said subsection being directed perpendicularly to the ridges of each adjacent subsection of the textured surface.

5. An animal barn flooring system comprising a plurality of flooring elements according to claim 1 mounted end to end and in parallel rows by a supporting structure of beams and posts, with suitable lateral gaps between adjacent rows to allow the passage and discharge of waste excreted by animals in the barn.

6. A method of making a structural flooring element according to claim 1, comprising pressure forming rubber in a wringer press fitted with molding elements to form said rubber mat;
pouring concrete into a rectangular slab mold of the desired dimensions for a flooring element;
vibrating the concrete to consolidate its components and remove bubbles;
pressing into the upper surface of the curing concrete the side of the mat having the anchoring projections; and
completing the curing of the concrete.
